(19) United States
(12) Patent Application Publication
(10) Pub. No.: US 2007/0236684 A1
(43) Pub. Date: Oct. 11, 2007

(54) Reflection-testing device and method for use thereof

(75) Inventor: Ching-Lung Jao, Miao-li (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: ALTUS TECHNOLOGY INC., Miao-li Hsien (TW)

(21) Appl. No.: 11/644,272

(22) Filed: Dec. 21, 2006

(30) Foreign Application Priority Data
Apr. 7, 2006 (CN) 200610060223.2

(51) Int. Cl. G01B 9/00

(52) U.S. Cl. 356/124

(57) ABSTRACT

A reflection-testing device for reflection testing of a lens module (12) includes a light source (18), which can emit light in an annular pattern, and an image capturer (16). The light source is provided around the top end of the lens module, and the image capturer is provided near the other end of the lens module for receiving an optical signal through the lens module. A reflection testing method is also disclosed.

### CROSS-REFERENCE TO RELATED APPLICATION

This application is related to a co-pending U.S. patent application (Attorney Docket No. [US10718]), entitled “REFLECTION-TESTING DEVICE AND METHOD FOR USE THEREOF”, by Ching-Lung Jao. Such application has the same assignee as the present application and is concurrently filed herewith. The disclosure of the above-identified application is incorporated herein by reference.

### TECHNICAL FIELD

The present invention generally relates to reflection-testing devices and methods for use thereof.

### BACKGROUND

Nowadays, digital camera modules are in widespread use. Portable electronic devices such as mobile phones and personal digital assistants (PDAs) are becoming increasingly multifunctional, and digital camera modules are now widely available as a special feature for portable electronic devices, consequently the integration of digital camera modules and portable electronic devices has become an important part of mobile multimedia technology.

In manufacturing, as a result of material tolerance dimensions, material surface roughness, reflection and refraction, material match issues, assembly processes and capabilities, and so on, some unacceptable levels of reflection may be found after the lens module has been assembled, even though such reflection might not appear during lens module design.

Typical reflection testing methods usually include the steps of providing a specific light source emitting on a lens module to be tested, moving the light source to different light source angles, and using it to detect the presence of unwanted reflections. However, while, in use, the lens module receives light from every direction at the same time, using the method above only can test the reflections in one specific direction of the lens module at the same time. The method above requires individual testing for reflections for each direction and therefore requires a relatively long time.

Accordingly, what is needed is a reflection-testing device and method with greater efficiency.

### SUMMARY OF THE INVENTION

In one aspect thereof, a reflection-testing device for reflection testing of a lens module includes an annular-shaped light source and an image capturer, wherein the light source is placed around the top end of the lens module and the image capturer is provided near the other end of the lens module for receiving an optical signal through the lens module.

In another aspect thereof, a reflection testing method for a lens module comprises the following steps: providing a light source and placing it around a top surface of the lens module, the light source extending around the top surface of the lens module; providing an image capturer and placing it near the other end of the lens module; receiving the optical signal through the lens module and forming an image using the image capturer; and testing for the presence of unwanted reflections in the image.

Other advantages and novel features will become more apparent from the following detailed description when taken in conjunction with the accompanying drawings.

### BRIEF DESCRIPTION OF THE DRAWINGS

Many aspects of the reflection-testing device and method can be better understood with reference to the following drawings. The components in the drawings are not necessarily drawn to scale, the emphasis instead being placed upon clearly illustrating the principles of the present reflection-testing device. Moreover, in the drawings, like reference numerals designate corresponding parts throughout the several views.

FIG. 1 is a cross-sectional view of a reflection-testing device, in accordance with a first embodiment;

FIG. 2 is a top plan view of the reflection-testing device, in accordance with the first embodiment;

FIG. 3 is a cross-sectional view of the reflection-testing device with a baffle, in accordance with the first embodiment;

FIG. 4 is a cross-sectional view of the reflection-testing device, in accordance with a second embodiment;

FIG. 5 is a top plan view of the reflection-testing device, in accordance with the second embodiment; and

FIG. 6 is a cross-sectional view of the reflection-testing device with a baffle, in accordance with the second embodiment.

### DETAILED DESCRIPTION OF THE PREFERRED EMBODIMENTS

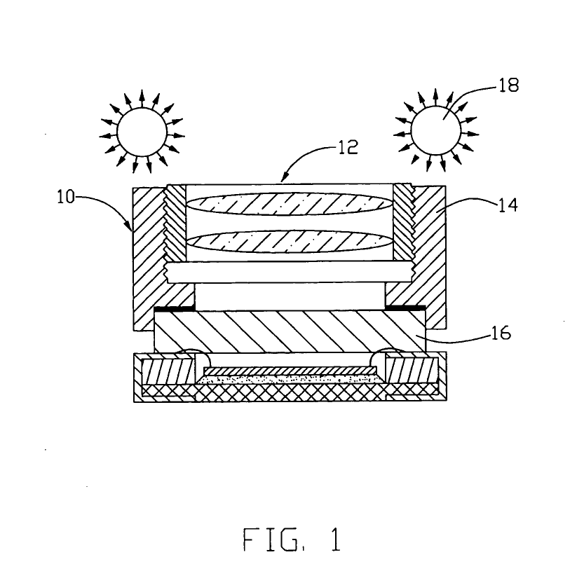

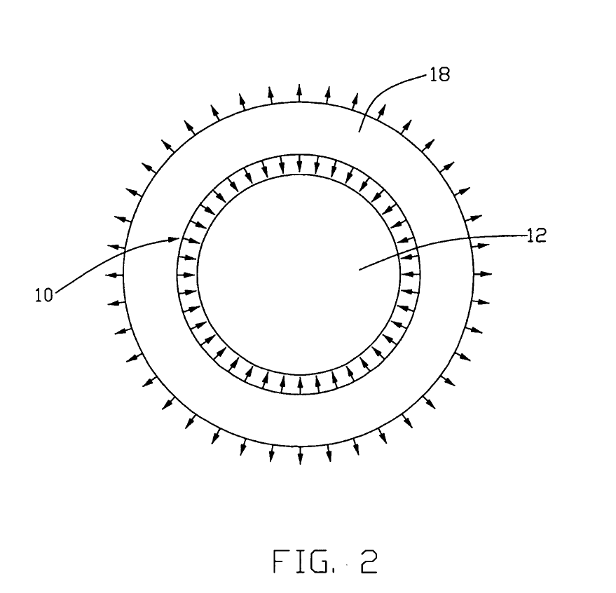

Referring to FIG. 1 and FIG. 2, an embodiment of a reflection-testing device is designed for testing optical devices such as cameras and telescopes. In the description, the optical device is a camera module 10.

The camera module 10 includes a lens module 12 and a barrel 14. The barrel 14 is a hollow cylinder with the lens module 12 received therein.

A first embodiment of the reflection-testing device includes an image capturer 16, an annular-shaped light source 18, and a signal processor (not shown). The image capturer 16 is an image sensor of a camera assembly to be tested. The annular-shaped light source 18 is provided for illumination. An inside diameter of the annular-shaped light source 18 is approximately equal to a size of the cross section of the lens module 12. A distance between the annular-shaped light source 18 and the camera module 10 can be adjusted. The annular-shaped light source 18 can be a light bulb (e.g., filament-type or fluorescent light source), light-emitting diode (LED) or another kind of light source. The signal processor is electrically connected with the image capturer 16.

The image capturer 16 is provided near one end of the barrel 14. The annular-shaped light source 18 is provided near the other end of the barrel 14 to simultaneously illuminate the lens module 12 from a plurality of different directions. The annular-shaped light source 18 and the lens module 12 both can be moved along an optical axis of the lens module 12. During testing, the annular-shaped light source 18 can be moved along the optical axis of the lens module 12 to emit light beams in different directions (e.g., at different angles relative to an upper surface of the lens module 12) for reflection testing.

An image is formed by the rays of light through the lens module 12. The image is received by the image capturer 16 and sent to the signal processor. The signal processor judges whether the lens module 12 is of sufficient quality based on the received image.

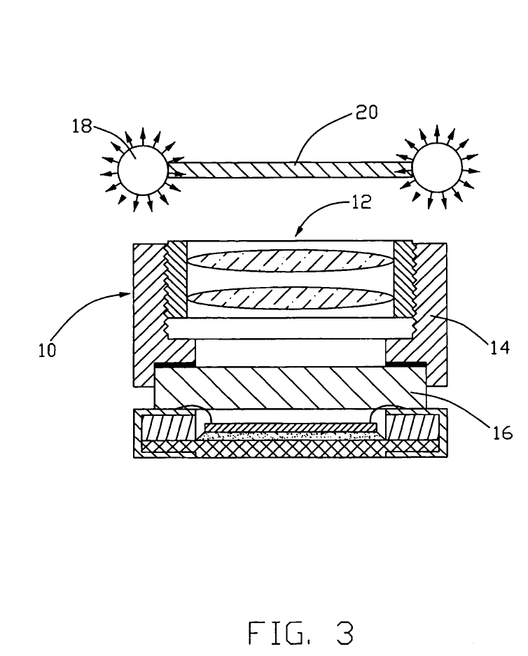

Further referring to FIG. 3, a baffle 20 is provided in a center of the annular-shaped light source 18. The baffle 20 faces the lens module 12 to make the lens module 12 reflections more easily distinguishable. The area of the baffle 20 is approximately equal to the area of the inside circle of the annular-shaped light source 18. That is, the area of the baffle 20 is approximately equal to the area of the cross section of the lens module 12.

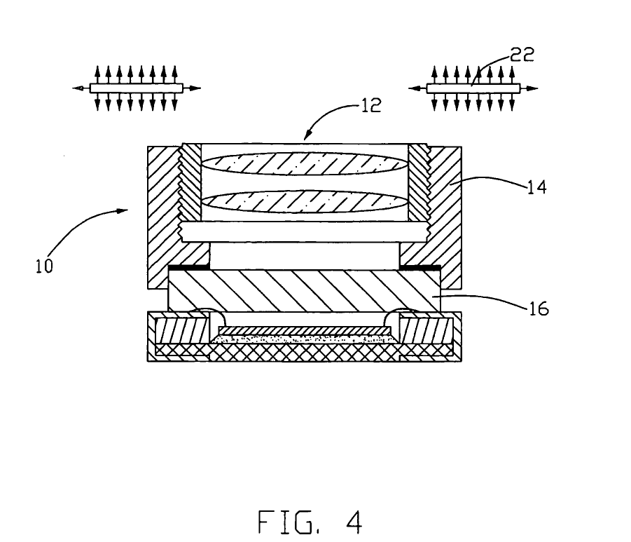

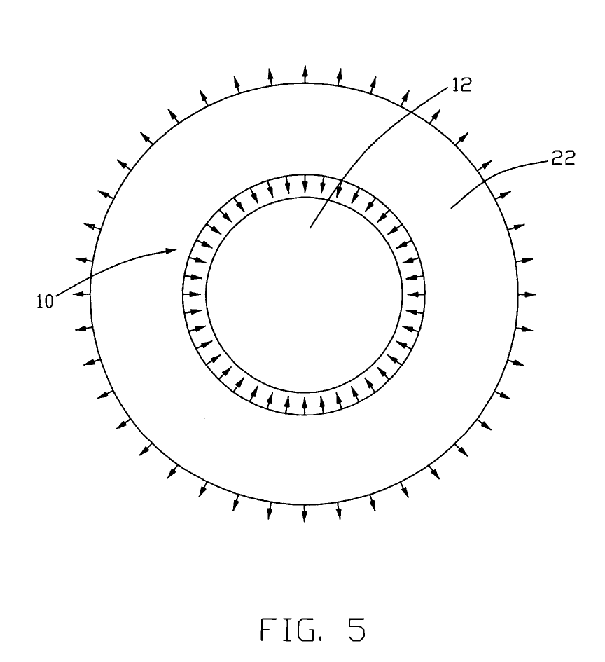

Referring to FIG. 4 and FIG. 5, in a second embodiment of the reflection-testing device, a large area annular-shaped light source 22 is provided, instead of the annular-shaped light source 18. The difference between the outside diameter and the inside diameter of the large area annular-shaped light source 22 is such that the area illuminated by the large area annular-shaped light source 22 is relatively large. The rays of light can radiate into the lens module 12, without moving the large area annular-shaped light source 22 or the lens module 12. The large area annular-shaped light source 22 can be a light bulb, light-emitting diode (LED) or some other kind of light source. The large area annular-shaped light source 22 is provided for illumination. The inside diameter of the large area annular-shaped light source 22 corresponds to the size of the cross section of the lens module 12.

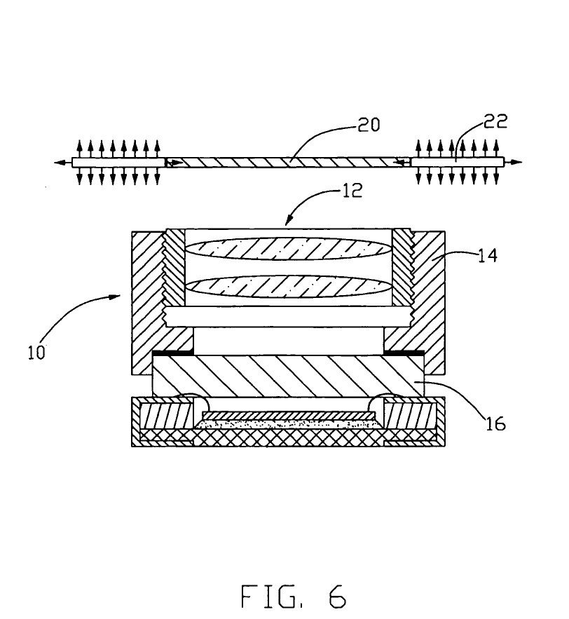

Referring to FIG. 6, the baffle 20 also can be provided in the center of the large area annular-shaped light source 22 to make the unwanted reflections more distinct. The diameter of the baffle 20 is approximately equal to the inside diameter of the large area annular-shaped light source 22.

The reflection testing method employing the reflection-testing device includes the following steps:

Providing an annular-shaped light source 18 and placing the annular-shaped light source 18 around the top surface of the lens module 12;

Providing an image capturer 16 and placing the image capturer 16 near the other end of the lens module 12;

Providing a signal processor connected with the image capturer 16; and

Receiving the optical signal through the lens module 12 and forming an image using the image capturer 16, then sending the image to the signal processor.

The signal processor processes the received image to detect the reflections of the lens module 12.

It should be understood that both the annular-shaped light source 18 and the large area annular-shaped light source 22 can be any light source that can emit light in a ring-shape. The reflection-testing device and method can test reflections from different directions of the lens module 12 simultaneously. Hence, reflection testing can be simplified, and the testing speed can be increased.

Alternatively, the reflections of the lens module 12 can be detected by naked-eye examination of the image picked by the image capturer 16, so that the signal processor can be omitted.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A reflection-testing device for testing a lens module for unwanted reflection, comprises:
a light source that can emit light in an annular pattern, wherein the light source extends around the top end of the lens module; and
an image capturer provided near the other end of the lens module, the image capturer being configured for receiving an optical signal through the lens module.

2. The reflection-testing device as claimed in claim 1, wherein the light source is one of a light bulb and a light-emitting diode.

3. The reflection-testing device as claimed in claim 1, wherein the light source is one of an annular-shaped light source and a large area annular-shaped light source, the large area annular-shaped light source have an inside circle area that corresponds to the area of the cross section of the lens module.

4. The reflection-testing device as claimed in claim 3, a baffle is provided in the center of one of the annular-shaped light source and the large area annular-shaped light source, the baffle faces towards the lens module, wherein the area of the baffle corresponds to the area of the cross section of the lens module.

5. A reflection testing method for reflection testing of a lens module comprising the following steps:
providing a light source around a top surface of the lens module, the light source surrounding the top surface of the lens module;
providing an image capturer and placing it near the other end of the lens module;
receiving an optical signal through the lens module and forming an image using the image capturer; and
testing for the presence of unwanted reflections in the image.

6. The reflection testing method as claimed in claim 5, wherein the light source and the lens module both can be moved along the optical axis of the lens module.

7. The reflection testing method as claimed in claim 5, wherein the light source is one of a light bulb and a light-emitting diode.

8. The reflection testing method as claimed in claim 7, wherein the light source is one of an annular-shaped light source and a large area annular-shaped light source, the large area annular-shaped light source have an of inside circle area that corresponds to the area of the cross section of the lens module.

9. The reflection testing method as claimed in claim 8, a baffle is provided in the center of one of the annular-shaped light source and the large area annular-shaped light source, the baffle faces the lens module, wherein the area of the baffle corresponds to the area of the cross section of the lens module.
